(19) United States
(12) Patent Application Publication
(10) Pub. No.: US 2026/0244030 A1
(43) Pub. Date: Aug. 20, 2026

(54) RETENTION STRAP FOR QUICK PLACEMENT AND REMOVAL OF EYEWEAR

(71) Applicant: Ching Man Wong, HONG KONG (CN)

(72) Inventor: Ching Man Wong, HONG KONG (CN)

(21) Appl. No.: 19/345,531

(22) Filed: Sep. 30, 2025

Related U.S. Application Data
(63) Continuation-in-part of application No. 19/055,558, filed on Feb. 18, 2025.

(51) Int. Cl. G02C 3/00; A45C 13/00

(52) U.S. Cl. CPC G02C 3/006; A45C 13/001

(57) ABSTRACT

A retention strap for quick placement and removal of eyewear includes a base strap and a fixing portion located at an end of the base strap, and the base strap is provided with a connecting portion configured for temples of the eyewear to pass through for securing the eyewear. The retention strap can provide significant convenience and comfort during outdoor activities and daily life. It not only reduces the risk of damage or loss of the eyewear and ensures quick placement and removal of the eyewear, but also enhances versatility and market competitiveness of the retention strap, better meeting the demands of people for an efficient and convenient modern lifestyle.

### CROSS-REFERENCE TO RELATED APPLICATIONS

This application is a continuation-in-part of U.S. application Ser. No. 19/055,558, filed Feb. 18, 2025.

### TECHNICAL FIELD

The present disclosure relates to the field of hanging accessories, and in particular to a retention strap for quick placement and removal of eyewear.

### BACKGROUND

Existing eyewear retention devices are primarily based on eyewear clips, which usually achieve fixation by clamping frames of the eyewear. These devices can meet basic requirements in some scenarios, but they are inconvenient during actual use. When using a clip to secure frames of the eyewear, a user needs to manually align the clip with a specific position on the frame and perform precise operation. This process is not only time-consuming and labor-intensive but also results in an undesirable user experience, particularly in scenarios where the eyewear needs to be frequently put on and taken off. Furthermore, the design of existing clips is relatively simple and cannot accommodate eyewear frames of varying materials and thicknesses, resulting in poor compatibility. For example, for thin or soft frames, the clip may exert excessive pressure during use, potentially damaging the frames. Conversely, for thicker frames, the clip may lack sufficient clamping force, causing the eyewear to slip and increasing the risk of loss or damage to the eyewear during use.

Especially during outdoor activities such as hiking, cycling, and other sports, users often need to quickly put on or take off their eyewear under varying environmental conditions. For example, during hiking, a user may wear sunglasses in strong sunlight but remove them in shaded or darker areas, making quick and secure placement of the eyewear essential. Similarly, during cycling, a user may no longer need eyewear when passing through tunnels, entering shaded areas, or experiencing changing weather conditions. Without a safe and convenient retention method, the eyewear may slip, get scratched, or be damaged during the activity. Conventional approaches, such as placing eyewear in a bag or hanging them on a collar, partially address the problem, but they are inconvenient and lack safety. For example, placing eyewear in a bag requires stopping to open the bag, which is time-consuming and has the risk of losing the eyewear during exercise. Hanging eyewear on a collar may lead to slippage or collisions, failing to effectively protect the eyewear.

The problems associated with existing eyewear clips and retention methods primarily arise from design limitations. Conventional eyewear clips only provide a single clamping fixation method, which lacks the flexibility to adapt to diverse scenarios and various eyewear designs, make the clips difficult to meet the demands of quick placement and removal of the eyewear, especially during outdoor activities. The complexity of operation and inadequate fixation of the eyewear clips further affect the efficiency and safety of placing and securing the eyewear by the user during use. In addition, most existing eyewear clips can only be installed in specific positions and cannot be flexibly combined with backpacks, hats, clothing, or other items, limiting their applicability in various scenarios. These deficiencies result in a poor user experience and do not provide versatility in practical use.

In order to solve the above problems, it is desirable to develop a multifunctional eyewear retention strap.

### SUMMARY

An objective of the present disclosure is to overcome at least one deficiency of the prior art by providing a retention strap for quick placement and removal of eyewear. The retention strap can provide a user with significant convenience and comfort during outdoor activities and daily life. It not only reduces the risk of damage or loss of the eyewear and ensures quick and convenient access to the eyewear, but also enhances versatility and market competitiveness of the retention strap, better meeting the demands of people for an efficient and convenient modern lifestyle.

To achieve the foregoing objective, the present disclosure provides a retention strap for quick placement and removal of eyewear. The retention strap includes a base strap and a fixing portion located at an end of the base strap, and the base strap is provided with a connecting portion through which temples of the eyewear pass to secure the eyewear.

In some embodiments, the base strap is flexible and deformable.

In some embodiments, the connecting portion is at least one through hole extending through the base strap for the temples to pass through.

Further, a silicone ring is disposed at the through hole to increase friction and reduce contact wear.

Further, an auxiliary strap is disposed on a back surface of the base strap, and two ends of the auxiliary strap are fixed to the back surface of the base strap to form a hanging structure with the base strap, thereby providing an auxiliary hanging position for cooperating with the through hole, such that the temples of the eyewear, after passing through the through hole from a front surface of the base strap, further pass through the auxiliary hanging position on the back surface of the base strap, thereby achieving stable fixation.

In some embodiments, the connecting portion is at least one elastic strap disposed on one surface of the base strap, two ends of the elastic strap are fixed to the base strap to form a hanging structure with the base strap, thereby providing a hanging position for hanging an item.

In some embodiments, the connecting portion is at least one connecting member having a hole/slot fixed on one surface of the base strap.

Further, two connecting members are provided, and the two connecting members are arranged in a straight line.

In some embodiments, the base strap is a fabric strap or a rubber strap.

In some embodiments, a flocked layer is disposed on the front surface and/or the back surface of the base strap.

In some embodiments, a magnet is embedded in the base strap.

In some embodiments, a clip for clamping an item is disposed at a lower end of the retention strap.

In some embodiments, a magnet for securing an item is disposed at a lower end of the retention strap.

In some embodiments, the fixing portion is an annular member having a controllable opening.

In some embodiments, the fixing portion is a magnetic component.

In some embodiments, the fixing portion is a block/plate having an adhesive surface.

Compared with the prior art, the present disclosure has at least one of the following beneficial effects:
1. The retention strap has a flexible structural design that allows the deformable base strap to accommodate eyewear of different types and sizes, thereby enabling quick and safe placement and removal of the eyewear and facilitating user operation.
2. A silicone ring at the through hole effectively increases the friction, reduces slippage of the temples, and minimizes contact wear, thereby extending the service life of the retention strap.
3. The auxiliary hanging position and the elastic strap provide a stable fixing structure, ensuring that the eyewear will not easily loosen when secured to the retention strap, thereby improving stability.
4. The connecting portion of the retention strap can take various forms and can be used for hanging various items, thereby increasing versatility of the retention strap and adapting to different usage scenarios.
5. The base strap is internally provided with a magnet, and the fixing portion has the magnetic characteristics, thereby introducing auxiliary functions, making the retention strap more convenient, and facilitating use in combination with other metal objects.

The above advantageous effects described are not exhaustive. Other potential advantages and detailed technical implementations will be further disclosed in the embodiments or other portions of the present disclosure.

### BRIEF DESCRIPTION OF THE DRAWINGS

Various aspects of the present disclosure will be better understood by reading the following detailed description in conjunction with the accompanying drawings. It should be noted that the positions, dimensions, and ranges of various structures shown in the drawings are not necessarily represent their actual positions, dimensions, and ranges. In the accompanying drawings:

FIG. 1 is a schematic structural diagram of Embodiment 1 according to the present disclosure, and a base strap in the figure is a silicone strap.

FIG. 2 is a schematic structural diagram of Embodiment 1 according to the present disclosure from a side view.

FIG. 3 is a reference diagram of Embodiment 1 according to the present disclosure in a use state from a front view.

FIG. 4 is a reference diagram of Embodiment 1 according to the present disclosure in a use state from a back view.

FIG. 5 is a reference diagram of Embodiment 1 according to the present disclosure in a use state from a perspective view.

FIG. 6 is a reference diagram of Embodiment 1 according to the present disclosure in a use state from a top view.

FIG. 7 is a reference diagram of Embodiment 1 according to the present disclosure in a use state from a bottom view.

FIG. 8 is a reference diagram of Embodiment 1 of the present disclosure in a use state with a retention strap attached to a handbag.

FIG. 9 is a schematic structural diagram of a base strap in Embodiment 2 according to the present disclosure, and the base strap in the figure is a fabric strap.

FIG. 10 is a schematic structural diagram of a base strap in Embodiment 2 according to the present disclosure from a side view.

FIG. 11 is a schematic structural diagram of a base strap in Embodiment 3 of the present disclosure from a front view.

FIG. 12 is a schematic structural diagram of a base strap in Embodiment 3 of the present disclosure from a back view.

FIG. 13 is a schematic structural diagram of a base strap in Embodiment 4 according to the present disclosure from a front view, where a connecting portion in this embodiment is an elastic strap.

FIG. 14 is a schematic structural diagram of a base strap in Embodiment 5 according to the present disclosure from a front view, where a connecting portion in this embodiment is a magnetic component.

FIG. 15 is a schematic structural diagram of a base strap in Embodiment 6 according to the present disclosure from a perspective view.

FIG. 16 is a schematic structural diagram of a base strap in Embodiment 6 according to the present disclosure from a side view.

FIG. 17 is a reference diagram of a base strap in Embodiment 6 according to the present disclosure in a use state from a perspective view.

FIG. 18 is a reference diagram of a base strap in Embodiment 6 according to the present disclosure in a use state from a side view.

FIG. 19 is a schematic structural diagram in Embodiment 7 according to the present disclosure from a perspective view.

FIG. 20 is a schematic structural diagram of Embodiment 8 according to the present disclosure from a front view.

FIG. 21 is a reference diagram of Embodiment 8 of the present disclosure in a use state with a retention strap used together with a suitcase.

### DESCRIPTION OF EMBODIMENTS

The present disclosure will now be described with reference to the accompanying drawings, in which several embodiments of the present disclosure are illustrated. However, it should be understood that the present disclosure may be presented in many different forms and is not to be limited to the embodiments described below. In fact, the embodiments described below are provided to make the present disclosure more complete and to fully illustrate the scope of protection of the present disclosure to those skilled in the art. It should further be understood that the embodiments disclosed herein may be combined in various ways to provide more additional embodiments.

It should be understood that, throughout all of the drawings, identical reference numerals refer to the same elements. In the drawings, some features may be distorted for clarity of illustration. In the accompanying drawings, for the sake of clarity, the dimensions of some features may be distorted.

It should be understood that the terms used in the specification is intended only to describe particular embodiments and are not intended to limit the present disclosure. Unless otherwise defined, all terms (including technical and scientific terms) used in the specification shall have the meanings commonly understood by those skilled in the art. For the sake of brevity and/or clarity, techniques, methods, and devices known to those of ordinary skill in the art may not be described in detail herein, but should be considered part of the authorized specification.

As used in the specification, the singular forms “a/an,” “the”, and “said” include the plural forms as well. As used herein, the terms “include/comprise,” “including/comprising,” “contain” specify the presence of stated features, but do not preclude the presence of one or more additional features. The term “and/or” used in the specification includes any and all combinations of one or more of the associated listed items.

### Embodiment 1

This embodiment provides a retention strap for quick placement and removal of eyewear. Through various functional designs, the retention strap meets users'needs for securely suspending and conveniently placing and removing the eyewear in various scenarios.

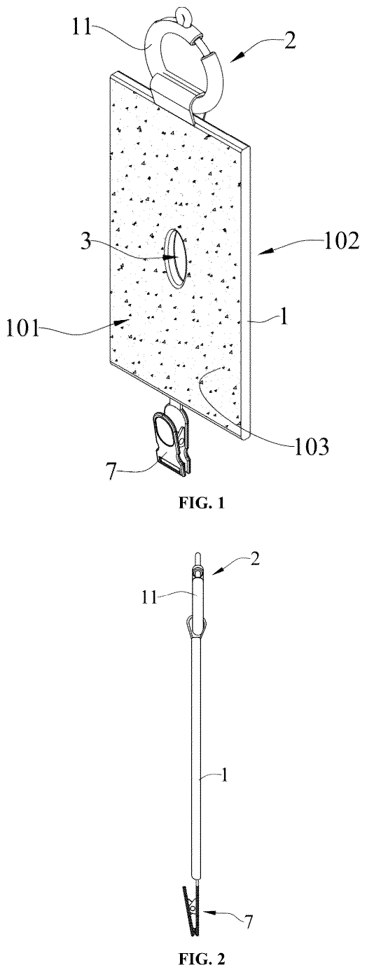

Referring to FIGS. 1 and 2, a structure of the retention strap includes a base strap 1, a fixing portion 2 disposed at an end of the base strap 1, and a connecting portion configured for securing the eyewear. These components cooperate with one another to form a multifunctional and easy-to-operate eyewear retention device.

First, it should be understood that the base strap 1 of the retention strap is made of a flexible material, such as fabric or rubber. The flexible base strap 1 is lightweight, soft, and can naturally bend and adapt to eyewear frames of different sizes and shapes.

The design of the base strap 1 fully considers the frequent and diverse use of eyewear in outdoor activities or daily life. For both sunglasses and myopia glasses, the users can hang and retain them easily on the retention strap without concern for size limitations.

Still referring to FIG. 1, to further improve user experience, a flocked layer 103 may be added to a front surface 101 and/or a back surface 102 of the base strap 1. This design not only improves the comfort of the retention strap but also reduces abrasion of the retention strap to the eyewear at points of contact.

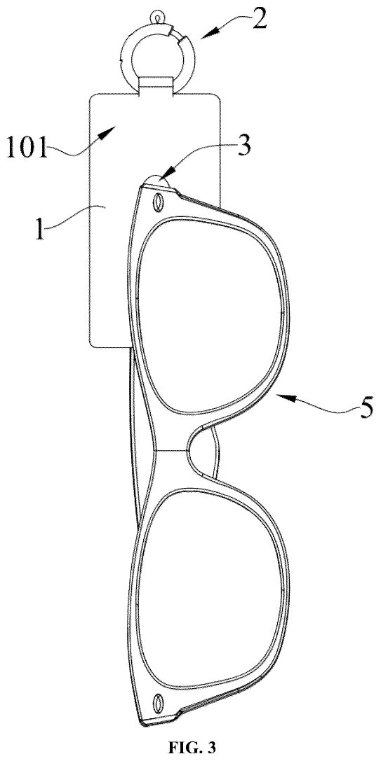

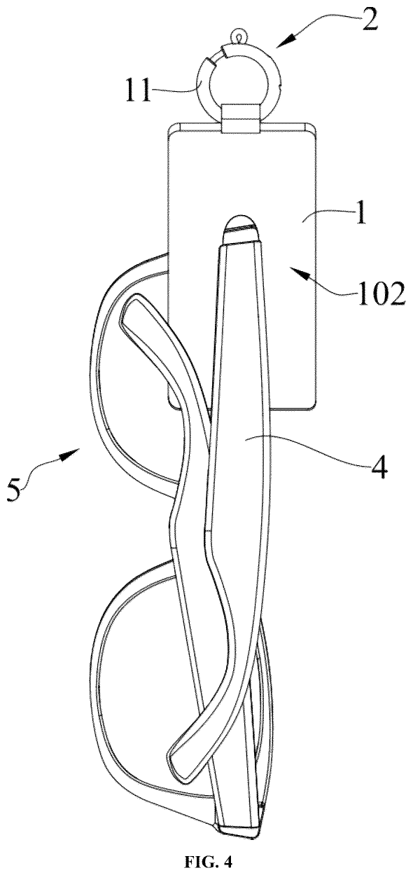

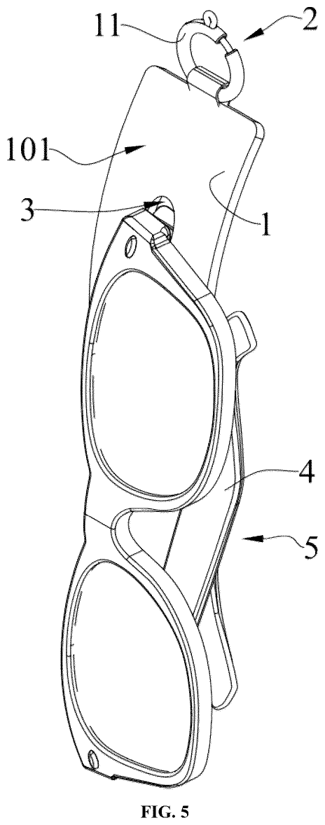

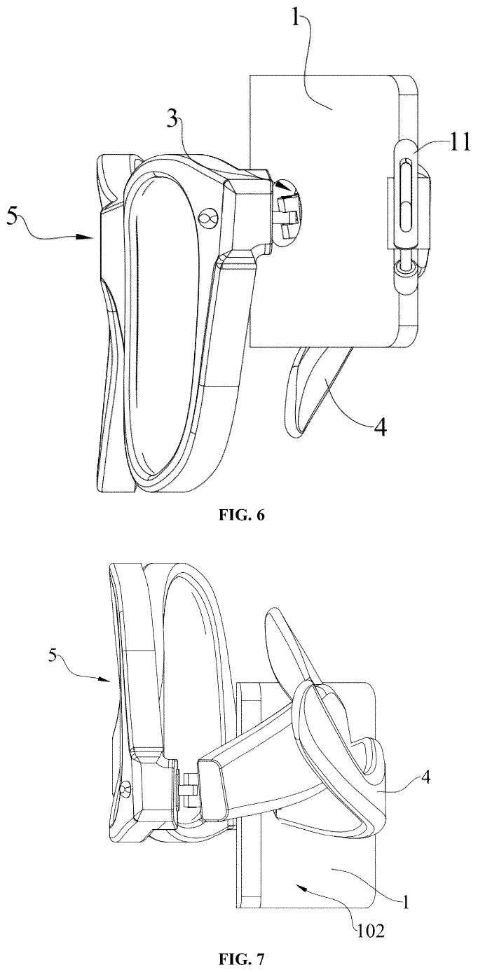

In this embodiment, referring to FIGS. 3-7, the connecting portion on the base strap 1 is configured for the temples 4 to pass through for securing the eyewear 5. The connecting portion is designed as a through hole 3 that extends through the base strap 1. When the eyewear 5 needs to be hung, the user only needs to simply insert the temples 4 into the through hole 3, thereby securely hanging the eyewear 5.

In some sports scenarios, such as running, hiking, or cycling, the user needs to frequently put on and take off the eyewear. The retention strap allows the user to easily insert the temples 4 into the through hole 3 with one hand, preventing the eyewear 5 from falling or being lost. In addition, this design avoids the cumbersome operation of precise alignment required by the conventional eyewear clips, significantly improving ease of use.

In practice, the base strap 1 is flexible and may be made of fabric or rubber. Both materials have advantages in performance and application, satisfying usage requirements in different scenarios.

Fabric is a commonly used material, typically made from nylon, polyester, or cotton fibers. These materials exhibit exceptional strength and wear resistance, making them particularly suitable for use in environments requiring frequent use or exposure to external forces.

The woven structure of the fabric strap provides excellent flexibility and elasticity. Another advantage of the fabric strap is its comfort. When the retention strap needs to be in contact with the skin for an extended period, the soft texture of the fabric strap reduces friction and avoids skin irritation. Therefore, the base strap 1 made of the fabric material is highly suitable for outdoor activities or prolonged wear scenarios. For example, during hiking or cycling, the user can hang sunglasses on the fabric strap. The strength and resilience of the fabric strap ensure that the eyewear remains securely in place even during strenuous exercise.

Further, the fabric strap is highly durable and can maintain its function and shape even with frequent use. Therefore, the base strap 1 made of fabric performs well in daily life and is suitable for hanging items such as eyewear, portable devices, or tools.

Referring to the structure shown in FIGS. 1-8, the base strap 1 is a rubber strap. The rubber strap is typically made of soft materials such as rubber or silicone, exhibiting excellent anti-slip performance and good elasticity. The base strap 1 made of rubber offers significant advantages in preventing items from sliding, especially when hanging smooth items, as it provides improved gripping force. For example, during outdoor activities, the user can hang electronic devices such as a mobile phone or a camera on the rubber strap. The anti-slip property of the rubber strap ensures that these items do not slide or fall even during strenuous exercise or vibration.

Another important characteristic of rubber is its elasticity. Compared with the fabric strap, the rubber strap has excellent elasticity, allowing the through hole 3 to apply uniform pressure on different items, ensuring that items are securely held. This is particularly useful in scenarios where items need to be frequently placed and removed. For example, when the user needs to frequently take off and hang sunglasses during outdoor activities, the elasticity of the rubber strap allows the through hole 3 to automatically adapt to shape and size of the sunglasses without complex adjustment.

In addition, the rubber is water-resistant and chemical-resistant, making it suitable for use in humid or rainy environments. This ensures that the base strap 1 maintains stable performance under harsh conditions, making the rubber strap more reliable for outdoor adventures, mountaineering, and other harsh environments, and effectively tackling the changing climates and complex terrain.

In this embodiment, the fixing portion 2 is an annular member 11 with a controllable opening as shown in FIGS. 1-6 and FIG. 8.

This design allows the retention strap to be easily secured to various items, such as backpacks, hats, or clothing. The user can conveniently attach the retention strap to a desired position according to different needs, offering flexible and diverse hanging options.

For example, during hiking or travelling, the user can secure the retention strap to a shoulder strap of the backpack for easy placement and removal of the eyewear 5. During cycling, the user can secure the retention strap to an edge of a hat or a front placket of clothing, ensuring easy access to the eyewear. In addition, the annular member 11 is capable of being freely opened and closed, allowing the retention strap to be easily attached to or detached from other items. Compared with conventional fixing methods, the annular member 11 with the controllable opening makes operation more convenient and flexible, particularly suitable for scenarios requiring frequent placement and removal of the items.

The annular member 11 is typically made of metal, plastic, or other materials with sufficient strength and elasticity. The design of the annular member allows the user to manually control a size of the opening. In a closed state, the annular member 11 forms a closed loop structure, securely fixing the retention strap and other items. When connection or separation is needed, the user can simply operate the opening to open the annular member 11, hang or remove the item, and then return the annular member 11 to the closed state to complete fixation. This design ensures that the annular member 11 provides secure fixation and quick operation during use.

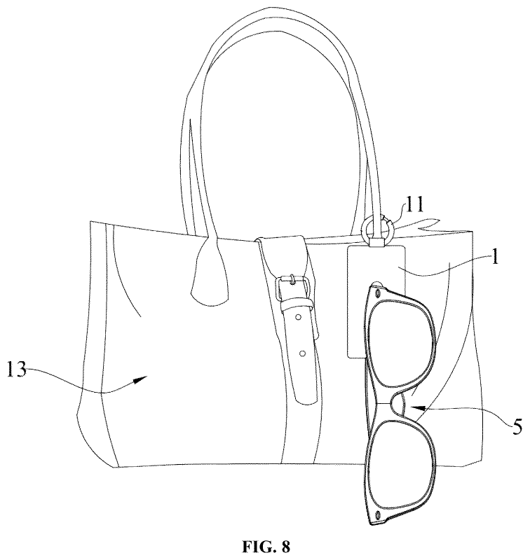

In daily life scenarios, referring to FIG. 8, the annular member 11 with the controllable opening provides a flexible and convenient user operation. For example, during job commuting, the user can attach the annular member 11 to a handbag 13 to hang keys, access cards, or other small personal items.

In addition, the annular member 11 is particularly suitable for a workplace, especially in scenarios requiring quick access to tools or equipment. The user can fix the annular member 11 to a tool belt or work uniform to hang small portable tools, such as screwdrivers or measuring tools. Since the annular member 11 can be manually opened and closed, the user can remove and hang tools at any time during operation without tedious steps of fastening or unfastening, thereby significantly improving work efficiency.

It should be understood that the annular member 11 is typically made of a durable material capable of withstanding substantial pulling force and wear, ensuring reliable functionality even after prolonged use.

In addition, a lower end of the base strap 1 is provided with a clip 7 or a magnet (not shown in the figures) for holding an item.

Referring to FIGS. 1 and 2, in one embodiment, a clip 7 is used. The clip 7 is configured to mechanically clamp the item to achieve secure fixing and hanging. The structure and design of the clip are intended to provide stable and reliable clamping effect, particularly suitable for clamping various small items such as papers, cards, and hats, thereby enhancing the versatility and practicality of the retention strap.

The clip 7 is usually made of a strong and durable material, such as metal or high-strength plastic, to ensure the clip can withstand repeated clamping and placement operations without damage. Proper clamping force is required for the clip 7, ensuring that it can securely hold the item without exerting excessive pressure on the item, thereby preventing the item from damage.

The clip 7 is operated in a simple manner. Specifically, the user gently presses both sides of the clip 7 to open jaws of the clip, and places the item inside the jaws, and then release to allow the clip 7 to automatically clamp the item. This operational method makes the retention strap more convenient to use, particularly when the user needs to quickly place or remove the item, allowing single-handed operation. For example, during outdoor activities, the user can quickly clamp an item such as a hat or gloves into the clip 7, ensuring that the item is safely hung on the retention strap when not in use and are readily accessible.

The clip 7 is also highly adaptable, and is capable of clamping items of varying thickness and materials. For example, while camping or hiking, the user can clip a map or a route guide into the clip 7 for easy access. This design is particularly suitable for scenarios requiring quick access, avoiding the need to frequently open a backpack or a pocket. In addition, the strong clamping force of the clip 7 ensures that items will not easily fall out of the clip even in strong wind or during strenuous exercise.

In office scenarios, the clip 7 is configured to hang items such as documents, notes, or business cards. The user can clamp these items into the clip 7 and secure them to an edge of a desk or a bag for easy access. The clip 7 not only provides stable hanging but also expands a range of the retention strap in daily life.

In order to enhance the practicality and durability of the clip 7, the clip 7 usually adopts a spring structure to ensure that the jaws of the clip can quickly return to an original position after each opening. The elasticity of the spring is carefully adjusted to provide sufficient clamping force while ensuring comfortable operation of the clip, such that the user can operate the clip 7 easily without excessive effort.

### Embodiment 2

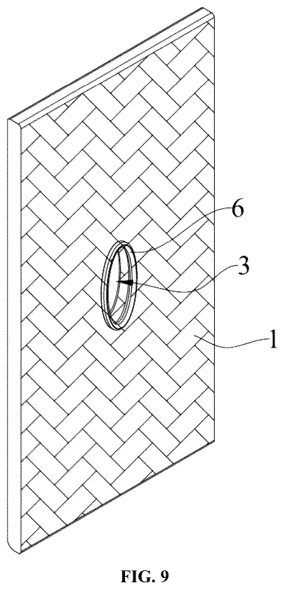

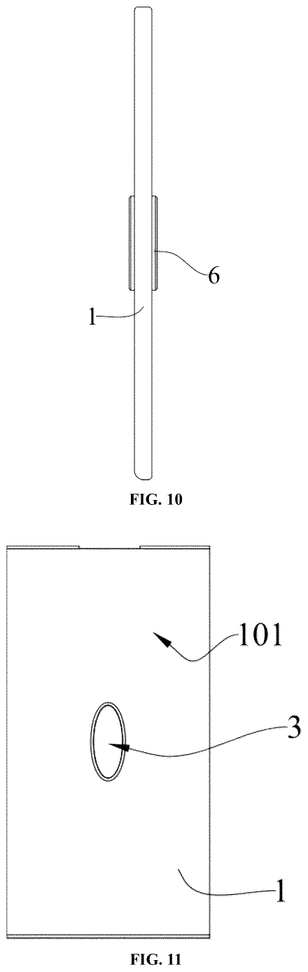

In a structure shown in FIGS. 9 and 10, the base strap 1 is made of fabric. In addition, a through hole 3 directly formed in the fabric strap cannot provide sufficient fixation, as the through hole 3 lacks elasticity. To further optimize the fixation of the temples 4 in the through hole 3, a silicone ring 6 is disposed within the through hole 3. The silicone ring 6 exhibits strong friction, which can effectively prevent the eyewear from sliding on the retention strap, thereby reducing the risk of the eyewear 5 falling due to frequent movement or external vibrations. Especially during strenuous exercise, such as trail running or mountaineering, the silicone ring 6 ensures that the eyewear 5 remains stable on the retention strap, preventing the eyewear 5 from damage caused by vibration or displacement. In addition, the silicone ring 6 is made of soft silicone material, effectively reducing wear between the temples 4 and the through hole 3, thereby extending a service life of the eyewear 5.

In use scenarios, for example, when the user is hiking outdoors under changing weather conditions, sunglasses may need to be frequently put on and taken off. Using the retention strap, the user can quickly secure the eyewear 5 by inserting the temples 4 through the through hole 3 without worrying about the eyewear 5 falling. The presence of the silicone ring 6 ensures that the eyewear 5 does not slide due to motion or wind, allowing the user to focus on walking or other activities without constantly adjusting a hanging position of the eyewear 5. For extended outdoor activities, such as mountaineering or off-roading, the retention strap also prevents the eyewear 5 from being worn or lost when not in use for an extended period, ensuring convenient and safe access to the eyewear 5 at any time.

### Embodiment 3

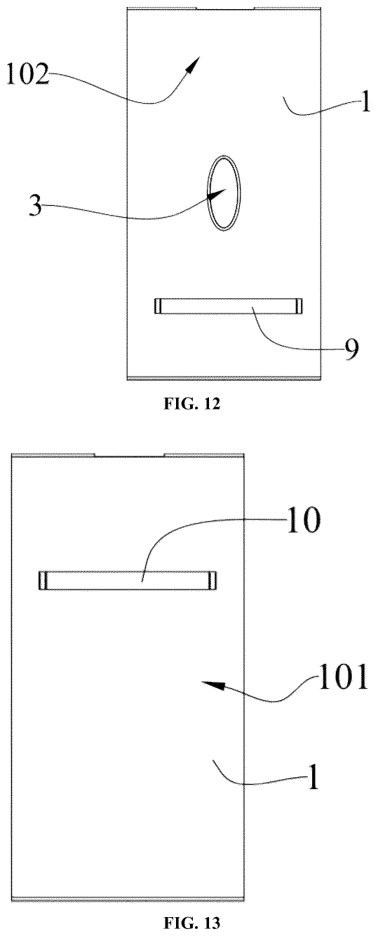

Referring to FIGS. 11 and 12, in order to further improve fixation and stability, an auxiliary strap 9 is disposed on the back surface 102 of the base strap 1, with both ends fixed to the back surface 102 of the base strap 1 to form an additional hanging structure. After passing through the through hole 3 on the front surface 101, the temples of the eyewear can further pass through the auxiliary strap 9, thereby providing additional fixation. This design provides the user with dual protection, ensuring that the eyewear remains firmly hung even during strenuous exercise or bumpy conditions, thereby avoiding the risk of slipping. Especially during outdoor cycling, where strong winds and vibrations make conventional hanging methods difficult to secure the eyewear, the auxiliary strap 9 provides additional stability, ensuring that the eyewear remains securely hung under various complex conditions.

### Embodiment 4

Referring to FIG. 13, in some other embodiments, the connecting portion may include at least one elastic strap 10 arranged on a surface of the base strap 1, instead of using the through hole 3. Two ends of the elastic strap 10 are fixed to the front surface 101 of the base strap 1, forming a hanging structure with the base strap 1 that is capable of providing a stable hanging position. The elastic strap 10 is typically made of highly elastic rubber or nylon, providing both flexibility and strong fixation effect for various items.

In this embodiment, in addition to being used to hang the eyewear, the retention strap can also be used to hang other items, such as keys, outdoor tools, or portable devices. When in use, the user simply threads and secures the item under the tension of the elastic strap 10, and the elastic strap 10 automatically tightens to ensure stable hanging. Compared with the through hole 3, the elastic strap 10 offers advantages in adaptability and convenience of operation, though its manufacturing is slightly more complex. It is particularly suitable for scenarios requiring quick placement and frequent removal of items.

For example, during camping or outdoor adventures, the retention strap may be attached to a backpack or a belt, such that the user can conveniently hang small outdoor devices, such as multi-tools, lighters, or other small tools. The tension of the elastic strap 10 allows the items to be easily secured, preventing the items from falling during movement. In addition, the user can quickly remove tools during use, making it extremely easy to operate and avoiding repeated placement and removal.

Similarly, during cycling or hiking, the user can use the elastic strap 10 to hang personal belongings, such as water bottles, phone pouches, or other commonly used items. The flexibility of the elastic strap 10 allows the user to make adjustments according to size and shape of different items, ensuring that the items remain securely fixed on the retention strap during traveling or exercising. The elastic strap 10 is made of a high-elasticity material, which can also absorb impact force to some extent, effectively maintaining the stability of the hung items during strenuous exercise and preventing the items from falling due to bumps or vibrations.

In addition, in daily use scenarios, such as shopping or commuting, the user can make use of the retention strap combined with bags, handbags, or other carrying items. The elastic strap 10 can be used to hang commonly used small items, such as keys or card holders, for convenient access by the user at any time. The elastic design of the elastic strap ensures secure hanging of the items while reducing wear on the retention strap caused by friction or frequent use.

### Embodiment 5

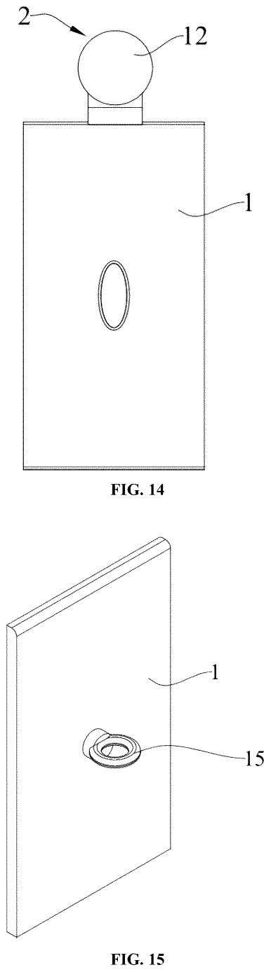

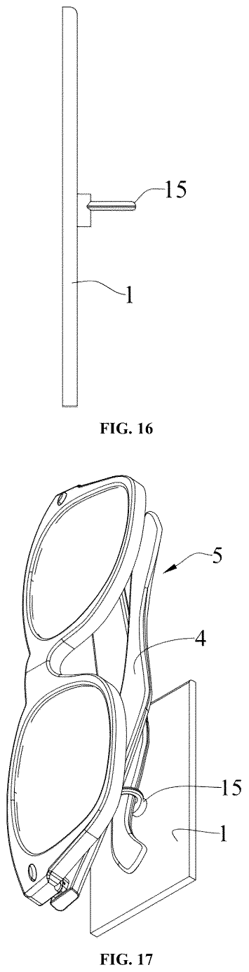

Referring to FIG. 14, the fixing portion 2 is provided with a magnetic component 12. Unlike conventional buckles or hook-and-loop fasteners, the magnetic component 12 enables rapid and convenient fixation of items via magnetic force. This design not only enhances the functionality of the retention strap but also greatly simplifies the operation process, especially suitable for scenarios requiring frequent hanging and rapid fixation.

The magnetic component 12 is typically made of a highly magnetic material, such as a neodymium-iron-boron magnet, which provides strong magnetic attraction in a compact form. The magnetic component 12 can be directly attached to a metal item without the need for additional tools or devices. When in use, the user simply brings the fixing portion 2 close to a metal surface, and the magnetic force automatically attracts and secures the fixing portion, completing the fixation.

For example, during outdoor activities such as hiking or cycling, the user can attach the magnetic component 12 to a metal buckle on a backpack or to a zipper of clothing. Due to the principle of magnetic attraction, the user can complete the fixation with simple operation. This allows the user to quickly hang the eyewear even during activities that require frequent removal and placement of eyewear, without the need to spend time unbuckling or tightening the buckle. Strong magnetic force of the magnetic component 12 also ensures that the retention strap does not come loose during strenuous exercise, thereby ensuring the safety of the eyewear or other hung items.

The magnetic component 12 is also suitable for a variety of daily life scenarios. The user can attach the retention strap to a metal surface at home or on a desk for hanging keys, earphones, or other small items. For example, for a desk, the user can attach the magnetic component 12 to a desk leg or other metal component for hanging the eyewear or keys at any time, keeping the desk neat and tidy. Since the magnet has the characteristics of instantaneous magnetic attraction, the item can be hung and removed quickly, without the need of additional steps.

In addition, in the workplace, the magnetic component 12 is particularly suitable for a factory or a workshop, enabling the user to temporarily secure tools or equipment to a metal surface for easy access. For example, the user can attach the magnetic component 12 of the retention strap to the metal surface of a workbench or a toolbox, allowing easy access to tools at any time. Compared with conventional fixation methods, the magnetic component 12 not only reduces the time required to secure and remove tools, but also improves operational flexibility and enhances work efficiency.

It should be understood that, to ensure durability in various use scenarios, the magnetic component 12 is typically encapsulated in a wear-resistant material, such as rubber or plastic. This encapsulation not only protects the magnet from wear and corrosion, but also prevents surrounding items from being scratched by the magnet. In addition, the encapsulation layer may be adjusted according to the overall design requirements of the retention strap to ensure consistency with both aesthetics and functionality of the retention strap.

### Embodiment 6

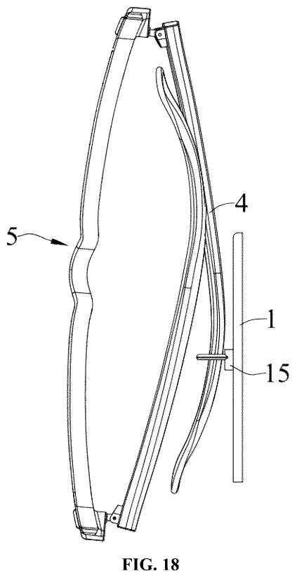

Referring to FIGS. 15 and 18, the connecting portion is at least one connecting member 15 with a hole or a slot that is fixed on a side of the base strap 1. The connecting member 15 provides a space for securing and hanging items through the hole or structure in the base strap 1, and can flexibly accommodate various types of eyewear or other items.

The connecting member 15 is a silicone member with a hole. Unlike a hole formed directly in the base strap 1, the hole of the connecting member 15 is raised above a surface of the base strap 1. After passing through the hole of the connecting member 15, the temples 4 of the eyewear 5 do not come into direct contact with the base strap 1. This design allows the eyewear 5 to be hung in a floating manner, greatly reducing friction and wear between the eyewear 5 and the surface of the base strap 1.

A silicone material is used for making the connecting member 15, as it is soft and elastic, allowing the temples 4 to pass through the hole in the connecting member 15 smoothly without excessive clamping force. In addition, a high coefficient of friction of silicone ensures that the temples 4 remain securely hung on the retention strap after passing through the hole, preventing them from easily sliding or falling. Even during outdoor activities or walking, the eyewear 5 that is hung in a floating manner maintains good stability.

Since the hole in the connecting member 15 is raised above the surface of the base strap 1, as shown in FIGS. 17 and 18, the temples 4 do not come into contact with the surface of the base strap 1 when the eyewear 5 is hung. This design reduces wear caused by friction, which is particularly suitable for eyewear with smooth or easily scratched surfaces of the temples 4. This “floating hanging” design not only extends the service life of the eyewear 5 but also provides better protection. For example, when the user does not wear the eyewear 5 for an extended period, the eyewear 5 can be securely hung on the retention strap via the connecting member 15, without worrying about the temples 4 being damaged due to prolonged friction with the base strap 1.

### Embodiment 7

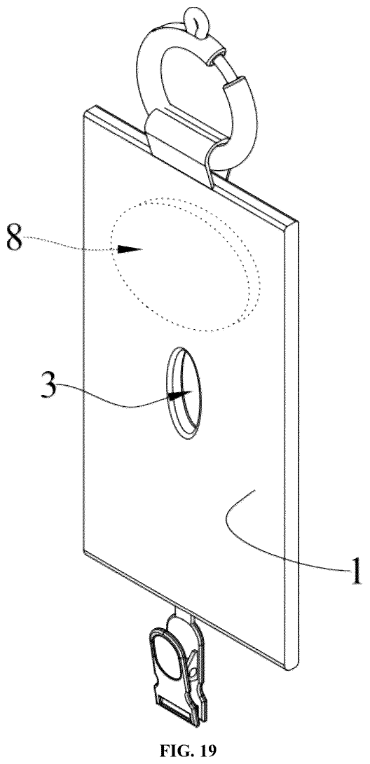

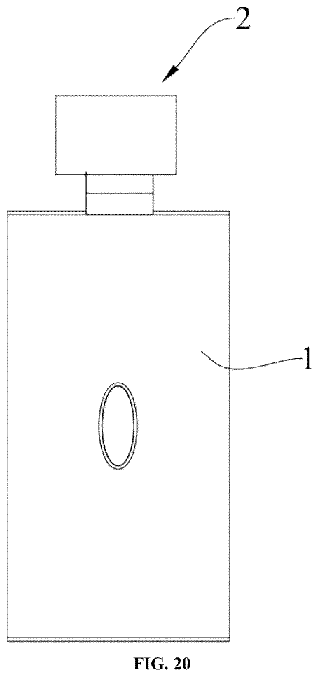

Referring to FIG. 19, in some other embodiments, to enhance functionality and flexibility, the base strap 1 is provided with the magnet 8. The design of the magnet 8 provides the retention strap with additional functionality and flexibility, making it particularly suitable for scenarios requiring quick fixation or release of the retention strap. The magnet 8 is typically embedded in the base strap 1. Through proper layout and installation, the retention strap can be used both by conventional hanging methods and via magnetic attraction for rapid fixation.

The magnet 8 is generally made of a strong magnet, such as a neodymium magnet, which exhibits strong magnetic force and can adhere to a metal surface or cooperate with other magnetic items. During use, the user can easily attach the retention strap to a metal item, such as a metal buckle on a backpack, metal zippers on clothing, or other metallic accessories, eliminating the tedious steps of fastening or tangling. This design greatly enhances the convenience of the retention strap, particularly in situations requiring quick operation.

For example, during outdoor activities such as hiking or rock climbing, the user often needs to frequently put on or take off the sunglasses, in which case, the user can quickly attach the retention strap to a metal component of the backpack or clothing using the built-in magnet 8 in the retention strap. The magnet 8 securely attaches to the retention strap, ensuring that the eyewear does not loosen during strenuous exercise, while providing a convenient and rapid hanging solution.

In addition, the magnet 8 can be used for hanging and securing the items in a variety of scenarios. For example, the user can attach the retention strap to a metal component inside a vehicle to hang eyewear, keys, or other small items. During daily commuting or driving, this design helps the user always keep his/her eyewear in a fixed position, preventing the eyewear from slipping or being lost. The strong magnetic attraction of the magnet 8 ensures that the retention strap remains firmly fixed even under bumps and vibrations.

For work scenarios, particularly for the user who needs to carry tools, the base strap 1 with the built-in magnet 8 provides a convenient function for hanging the tools. The user can hang a tool bag or tools on the magnetic retention strap and secure them to a toolbox, a metal bracket, or a workbench using the magnetic attraction. The inclusion of the magnet 8 not only improves operational flexibility but also reduces the time spent by the user in repeatedly accessing the tools.

It should be understood that to enhance comfort and aesthetics of the retention strap, and to avoid wear on the secured items due to vibration or displacement during magnetic attraction, the magnet 8 is completely embedded in the base strap 1, with no protruding parts visible externally. This concealed design ensures that the base strap 1 maintains flexibility and aesthetics, without the presence of the magnet 8 negatively affecting the overall user experience.

It should also be understood that when securing sunglasses or myopia glasses with ferromagnetic frames, the magnet 8 also attracts the frames and serves as a second fixation point in addition to the through hole 3, improving the stability of the eyewear fixation.

### Embodiment 8

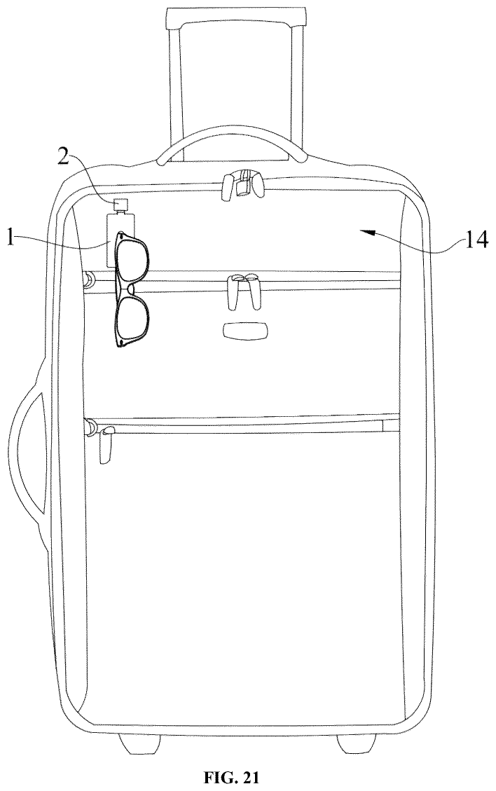

Referring to FIG. 20, in some embodiments, the fixing portion 2 may be a block or a plate having an adhesive surface, and is designed to provide more stable and reliable long-term fixation. Unlike temporary fixation, the fixing portion 2 is mainly configured to securely attach the retention strap to a fixed position, such as a suitcase, a tool bag, or a clothing surface, ensuring that the retention strap remains stable for an extended period without easy detachment.

An adhesive surface of the fixing portion 2 is made of a high-strength industrial adhesive material, providing strong adhesion and reliable fixation on various surfaces, including leather, fabric, plastic, or metal.

For example, referring to FIG. 21, the user can firmly adhere the fixing portion 2 to a surface of a suitcase 14 for hanging the eyewear, keys, or other small items. With this fixation method, the user does not need to worry about the retention strap loosening or shifting, allowing the item to be hung in a fixed position for an extended period, ensuring ready access to the item at any time. The fixing portion 2 with the adhesive surface is capable of withstanding various daily use conditions, such as vibrations, friction, or external pulling force on the backpack, without affecting its adhesive performance.

During outdoor activities or traveling, the fixing portion 2 with the adhesive surface provides the user with significant convenience. For example, the user can attach the retention strap to a side or a top of the suitcase 14 to secure the commonly used items such as a water bottle, a camera, or a first-aid kit.

Although exemplary embodiments of the present disclosure have been described above, those skilled in the art will appreciate that various modifications and changes can be made to the exemplary embodiments without departing from the spirit and scope of the present disclosure. Therefore, all such modifications and changes are intended to be included within the scope of protection of the present disclosure. The present disclosure is defined by the appended claims, and the equivalents of the claims are intended to be included therein.

What is claimed is:

1. A retention strap for quick placement and removal of eyewear, comprising a base strap and a fixing portion located at an end of the base strap, wherein the base strap is provided with a connecting portion through which temples of the eyewear pass to secure the eyewear.

2. The retention strap for quick placement and removal of eyewear according to claim 1, wherein the connecting portion is at least one through hole extending through the base strap and is configured for the temples to pass through.

3. The retention strap for quick placement and removal of eyewear according to claim 1, wherein an auxiliary strap is disposed on a back surface of the base strap, two ends of the auxiliary strap are fixed to the back surface of the base strap to form a hanging structure with the base strap, thereby providing an auxiliary hanging position for cooperating with the through hole; and the temples of the eyewear, after passing through the through hole from a front surface of the base strap, further pass through the auxiliary hanging position on the back surface of the base strap, thereby achieving stable fixation.

4. The retention strap for quick placement and removal of eyewear according to claim 1, wherein the connecting portion is at least one elastic strap disposed on one surface of the base strap, and two ends of the elastic strap are fixed to the base strap to form a hanging structure with the base strap, thereby providing a hanging position for hanging an item.

5. The retention strap for quick placement and removal of eyewear according to claim 1, wherein the connecting portion is at least one connecting member having a hole/slot fixed on one surface of the base strap.

6. The retention strap for quick placement and removal of eyewear according to claim 1, wherein a clip for clamping an item is disposed at a lower end of the retention strap.

7. The retention strap for quick placement and removal of eyewear according to claim 1, wherein a magnet for securing an item is disposed at a lower end of the retention strap.

8. The retention strap for quick placement and removal of eyewear according to claim 1, wherein the fixing portion is an annular member having a controllable opening.

9. The retention strap for quick placement and removal of eyewear according to claim 1, wherein the fixing portion is a magnetic component.

10. The retention strap for quick placement and removal of eyewear according to claim 1, wherein the fixing portion is a block/plate having an adhesive surface.
